(19) United States
(12) Patent Application Publication
(10) Pub. No.: US 2013/0044008 A1
(43) Pub. Date: Feb. 21, 2013

(54) ENHANCED EMERGENCY SYSTEM USING A HAZARD LIGHT DEVICE

(71) Applicants: Tom Gafford, Fort Worth, TX (US); Rand Mueller, Bonita Springs, FL (US)

(72) Inventors: Tom Gafford, Fort Worth, TX (US); Rand Mueller, Bonita Springs, FL (US)

(73) Assignee: GPSI, LLC, Madison Heights, MI (US)

(21) Appl. No.: 13/213,550

(22) Filed: Aug. 19, 2011

(51) Int. Cl. G08G 1/123; B60Q 1/52

(52) U.S. Cl. 340/989; 340/471

(57) ABSTRACT

The present invention relates to an emergency response system, method and apparatus. More specifically, the present invention relates to a system, method and apparatus for integrating emergency response functionality with a vehicle factory-installed emergency or hazard light device.

### TECHNICAL FIELD

The present invention relates to an emergency response system, method and apparatus. More specifically, the present invention relates to a system, method and apparatus for integrating emergency response functionality with a vehicle using existing input devices.

### BACKGROUND INFORMATION

Various in-vehicle emergency response systems are known in the art. Such emergency response systems are typically used to initiate and facilitate communication between a vehicle occupant and an emergency response center. Depending on the situation, the emergency response center may dispatch assistance to the vehicle's location. The assistance may include, for example, police, ambulance, fire department, or other forms of assistance, including, for example, roadside assistance. The vehicle's location may be determined using, for instance, triangulation techniques, a Global Positioning System (“GPS”), or by simply receiving location data from a vehicle occupant.

An exemplary emergency response system is available from OnStar®, a subsidiary of General Motors. OnStar® utilizes CDMA mobile phone voice and data communication technology to enable communication with a vehicle, while GPS technology is used to determine the vehicle's location. To activate OnStar®, a vehicle occupant may press either a red OnStar® emergency button or a blue OnStar® button. Once pressed, vehicle data and the vehicle's GPS location are sent to OnStar's® emergency response center. Once the call has been routed, an emergency technician may dispatch the appropriate assistance.

An additional exemplary emergency response system is disclosed in U.S. Patent Publication No. 2008/0143497 to Wasson et al., entitled “Vehicle Emergency Communication Mode Method and Apparatus” (“Wasson”). Wasson discloses a vehicle emergency communication mode, method and apparatus. Steps include detecting in the mobile unit an emergency signal; commencing a process of establishing communication from the mobile unit to a remote center in response to the detected emergency signal; providing an input prompt to a vehicle's operator during the process of establishing communication with the remote center, wherein the input prompt requests a response from the vehicle's operator indicative of a status of emergency; canceling the communication if the response indicates there is no emergency; and completing the process of establishing communication from the mobile unit to the remote center if the canceling is not achieved.

Similarly, U.S. Patent Publication No. 2008/0180237 to Fayyad et al., entitled “Vehicle Emergency Communication Device And A Method For Transmitting Emergency Textual Data Utilizing The Vehicle Emergency Communication Device” (“Fayyad”), discloses a vehicle emergency communication device and a method for transmitting emergency textual data utilizing the vehicle emergency communication device. The vehicle emergency communication device includes a diagnostic link connector configured to receive a signal indicating an emergency code associated with vehicle operation and a microprocessor operably coupled to the diagnostic link connector. The microprocessor is configured to determine emergency textual data based upon the emergency code and to induce the cellular phone transceiver to transmit an RF signal containing the emergency textual data and initiate an emergency phone call.

Despite the numerous advancements in emergency response systems, such systems are generally required to be installed at the factory, thereby eliminating the possibility of retrofitting an existing vehicle. OnStar® recognized this limitation, and, while OnStar® was initially available only for vehicles that had the factory-installed OnStar® hardware, more recently, OnStar® has begun offering a new retail rearview mirror with a built-in OnStar® module, branded as OnStar® FMV. OnStar® FMV provides some of the features of the original system, such as Automatic Crash Response, Stolen Vehicle Tracking, Turn-by-Turn Navigation, and Roadside Assistance. Nevertheless, while OnStar® FMV enables a user to retrofit a vehicle to include OnStar® functionality, it still requires the installation of additional user input devices within the vehicle's cabin.

Despite the advancements in the prior art, the prior art still requires the installation of additional user input devices. Installing these devices can be time-consuming, costly and, in many cases, visually unattractive. Accordingly, there is a need for an emergency response system, method and apparatus that may be integrated with a vehicle and that is enabled to use existing vehicular controls, thereby eliminating the need to install additional user input devices.

### SUMMARY

The present disclosure endeavors to provide an emergency response system, method and apparatus that integrates with a vehicle and is enabled to use existing vehicular controls, such as a hazard light device, thereby eliminating the need to install additional user input devices.

According to a first aspect of the present invention, a method for activating a vehicular emergency response system comprises the step of triggering a factory-installed hazard light device, wherein the hazard light device may be a factory-installed button. In certain aspects, the emergency response system may be triggered by (i) pressing the factory-installed button or (ii) pressing and holding the factory-installed button for at least 3 seconds.

According to a second aspect of the present invention, a method for using a factory-installed hazard light device in a vehicle to activate an emergency response system comprises the steps of: generating an emergency signal in response to the hazard light device being triggered; and transmitting said emergency signal to an emergency response center, wherein said emergency response center is enabled to take appropriate action in response to the emergency signal. In certain aspects, the method may further comprises the steps of generating GPS location data associated with the vehicle and transmitting the GPS location data and the emergency signal to the remote device, wherein the remote device is enabled to determine the location of the vehicle using the transmitted location data.

According to a third aspect of the present invention, a method for using a factory-installed hazard light device in a vehicle to activate a vehicular emergency response system comprises: receiving an emergency signal triggered by the factory-installed hazard light device, wherein said factory-installed hazard light device is further enabled to activate the vehicle's hazard lights; generating GPS location data associated with the vehicle; establishing a communication link between the vehicle and a remote device; and transmitting the GPS location data and the emergency signal to the remote device, wherein the remote device is enabled to determine the location of the vehicle using the transmitted location data.

According to a fourth aspect of the present invention, a vehicular emergency response system comprises: a factory-installed hazard light device used to activate the vehicle's hazard lights and also used for triggering an emergency signal; a CPU operatively coupled to said hazard light device and a memory device; a GPS device operatively coupled to said CPU and enabled to provide location data associated with the vehicle; and a communication device operatively coupled to said CPU for establishing a communication link with a remote device to transmit to the remote device the location data and the emergency signal.

According to a fifth aspect of the present invention, an emergency response apparatus in a vehicle comprises: a factory-installed dashboard on which is mounted a factory-installed emergency or hazard light device used to activate the vehicle's hazard lights; and a CPU, wherein said CPU is configured to receive as an input an emergency signal triggered by said factory-installed emergency or hazard light device and to establish a communications link with a device remote from the vehicle in response to the receipt of said emergency signal. In certain aspects, the system may include a GPS device coupled to said CPU for providing location data associated with the vehicle, said the emergency response center is enabled to take appropriate action in response to the receipt of said emergency signal and said location data.

In another aspect, the remote device may be an emergency response center and may enabled to take appropriate action in response to said emergency signal. In certain aspects, the appropriate action may be one or more of the following actions: (i) dispatching emergency personnel to the location of the vehicle; (ii) dialing a phone number associated with the vehicle; (iii) contacting an emergency contact associated with the vehicle; and (iv) notifying a government agency of the emergency.

In yet another aspect, the factory-installed hazard light device may be a factory-installed button and the emergency response system may be triggered by pressing and holding the factory-installed button for at least 3 seconds.

### BRIEF DESCRIPTION OF THE DRAWINGS

These and other advantages of the present invention will be readily understood with reference to the following specifications and attached drawings wherein:

FIG. 1a illustrates an exemplary system for using an emergency response system;

FIG. 1b is a block diagram of an exemplary system enabled to carry out the emergency response functionality;

FIGS. 2a and 2b illustrate an exemplary schematic of the system of FIG. 1b; and

FIG. 3 is a flow diagram illustrating an exemplary method for carrying out emergency response functionality.

### DETAILED DESCRIPTION

The present invention provides an emergency response system, method and apparatus for integration with a vehicle that is enabled to use existing vehicular controls, such as an emergency or hazard light device, thereby eliminating the need to install additional user input devices. Preferred embodiments of the present invention will be described hereinbelow with reference to the figures of the accompanying drawing. In the following description, well-known functions or constructions are not described in detail, since such description would obscure the invention in unnecessary detail. For this application, the following terms and definitions shall apply:

The terms “communicate” and “communicating,” as used herein, refer to both transmitting, or otherwise conveying, data from a source to a destination and delivering data to a communications medium, system, channel, network, device, wire, cable, fiber, circuit, and/or link to be conveyed to a destination.

The term “computer,” as used herein, refers to a programmable device designed to sequentially and automatically carry out a sequence of arithmetic or logical operations, including, without limitation, personal computers, handheld processor-based devices, and any other electronic devices equipped with one or more CPUs, processors or microprocessors.

The terms “Central Processing Unit” and “CPU,” as used herein, refer to processing devices, apparatus, programs, circuits, components, systems, and subsystems, whether implemented in hardware, tangibly embodied in software or both, and whether or not programmable. The term “CPU,” as used herein, may include, but is not limited to, one or more hardwired circuits, signal modifying devices and systems, devices and machines for controlling systems, programmable devices and systems, field-programmable gate arrays, application-specific integrated circuits, systems on a chip, systems comprising discrete elements, and/or circuits, state machines, virtual machines, and data processors.

The term “network,” as used herein, refers to networks and inter-networks of all kinds, including the Internet, but is not limited to any particular network or inter-network.

An emergency response system of the present invention may be integrated with any vehicle equipped with GPS functionality and/or wireless communication (e.g., via a cellular network). In certain embodiments, GPS, while generally more accurate, is not essential because triangulation techniques may be used to locate a vehicle using two or more transmitters in a cellular network.

To avoid the unwanted installation of superfluous buttons, switches and the like, an emergency response system of the present invention is preferably triggered (i.e., activated) using one or more existing vehicular input devices. For instance, an emergency or hazard light device (e.g., a switch or button for activating a vehicle's hazard lights), a device that is readily found in nearly every vehicle, may be used to trigger an emergency response signal. An emergency or hazard light device is be preferred because, in addition to its availability, it is (i) readily identifiable in an emergency situation (because of its often bright color and prominent location) and (ii) already known by consumers to connote an emergency situation. The factory-installed emergency or hazard light device, which is used to activate the vehicle's hazard lights, is preferably installed on the vehicle's factory-installed dashboard. While an factory-installed emergency or hazard light device is used in the present application, other existing, factory-installed, vehicular input devices may be used in conjunction with, or in lieu of, the hazard light device.

In certain aspects, while an emergency response system may be a separate system, it may also be integrated with existing factory-installed and after-market vehicle systems. For example, an emergency response system of the present invention may be integrated with an asset tracking system, including those available from GuidePoint Systems™ (“GuidePoint”). GuidePoint uses a state-of-the-art computer module equipped with a global positioning satellite (GPS) receiver, wireless data modem, and vehicle interface component that allows GuidePoint's Response Center to communicate with a vehicle. Each unit's unique electronic serial number, which may be similar to a cell phone number, allows information to be exchanged between the vehicle and GuidePoint's Response Center over a nationwide wireless network. For further information on GuidePoint's asset tracking system, see GuidePoint's Web site at http://www.guidepointsystems.com/index.shtml.

An exemplary asset tracking system enabled for use with an emergency response system is disclosed by commonly owned U.S. Patent Publication Number 2010/0179897 to Gafford et al., entitled “Asset Tracking System” (the “'897 publication”). The '897 publication discloses an asset tracking system for tracking a vehicle. The asset tracking system may optionally include a loan obligation management system integrated with the asset recovery system, which provides from a remote location in-vehicle notifications of loan obligations for the asset upon which the loan obligation is based.

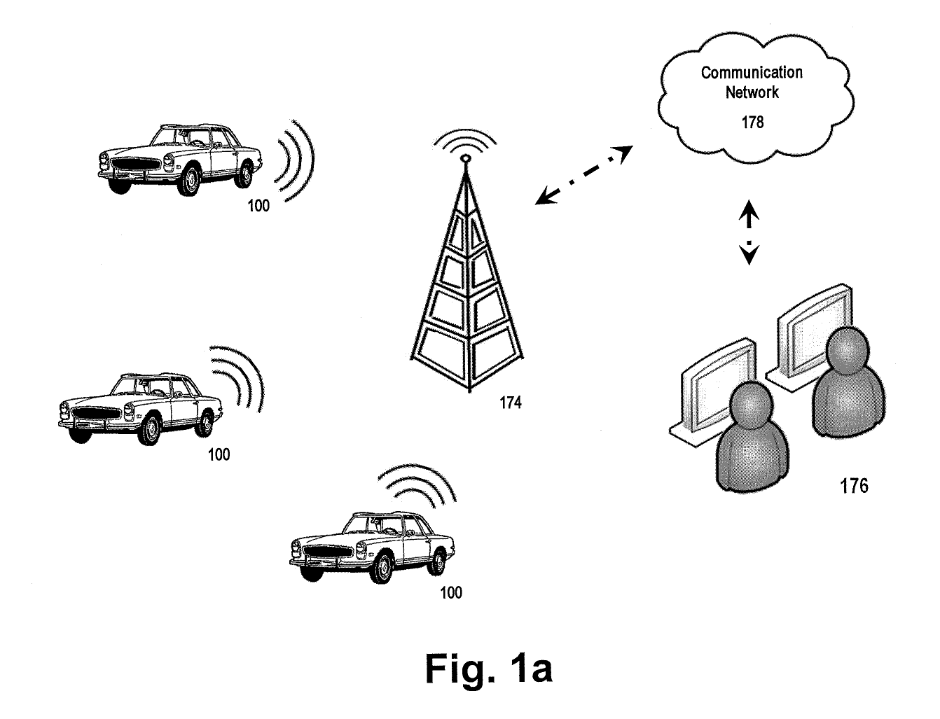

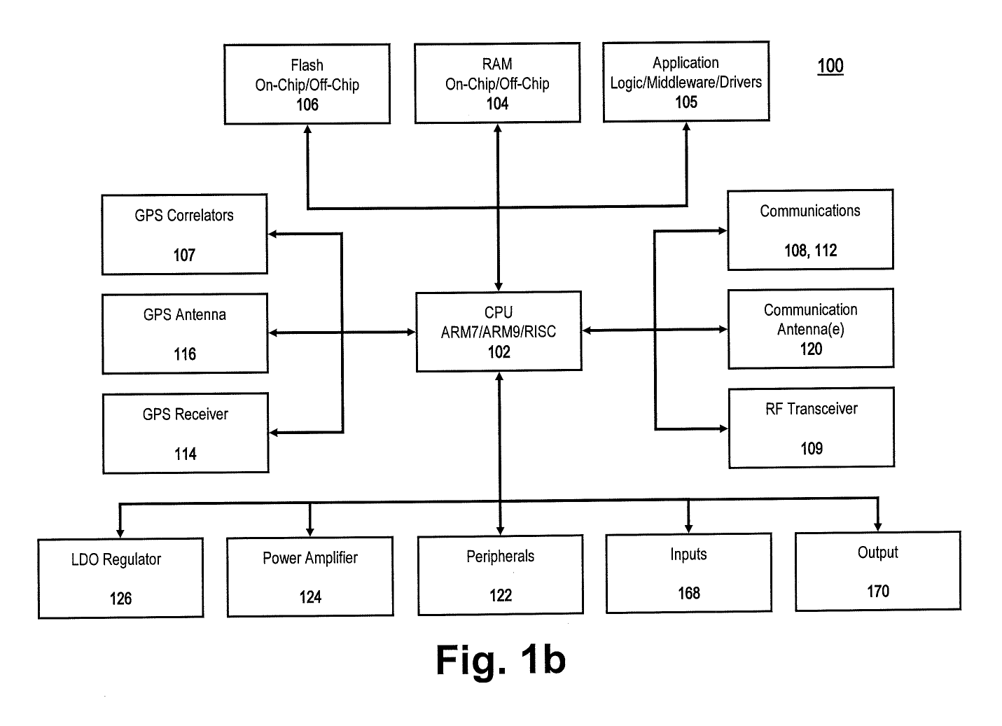

FIG. 1a illustrates an exemplary system for using an emergency response system 100. As illustrated, one or more vehicles may be equipped with an emergency response system 100. Each emergency response system 100 is enabled to communicate with an emergency response center 176 by way of, for example, one or more transmitter towers 174 and a communication network 178. While the communication link between the emergency response system 100 and the transmitter towers 174 is preferably wireless, the communication network 178 need not be limited to only wireless communication; rather, communication network 178 may employ wired and/or wireless communication techniques.

Turning now to FIG. 1b, illustrated is a block diagram of an exemplary system enabled to carry out emergency response functionality of the present invention. The system 100 includes a CPU 102, for example, a Reduced Instruction Set Computer (RISC), Model ARM7 or ARM9 CPU. The memory may be consolidated into a single RAM memory 104 and a single flash memory 106. Accordingly, software applications, such as the main application 105 and the GPS correlators 107, may reside on the same memory device, namely, the flash memory 106. In certain embodiments, depending on the needs of the user, the components of system 100 may be primarily assembled within a single housing to provide quick installation wherein various auxiliary devices may be located outside of the housing. Auxiliary devices may include, for example, sensors, input devices, antenna(e), and the like.

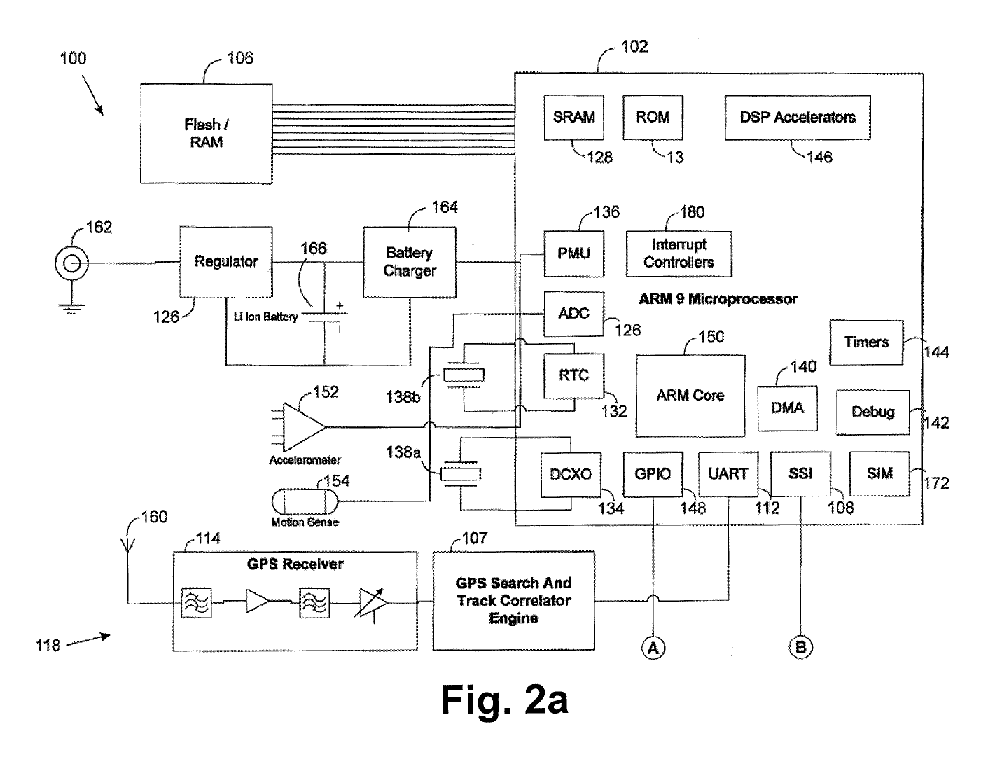

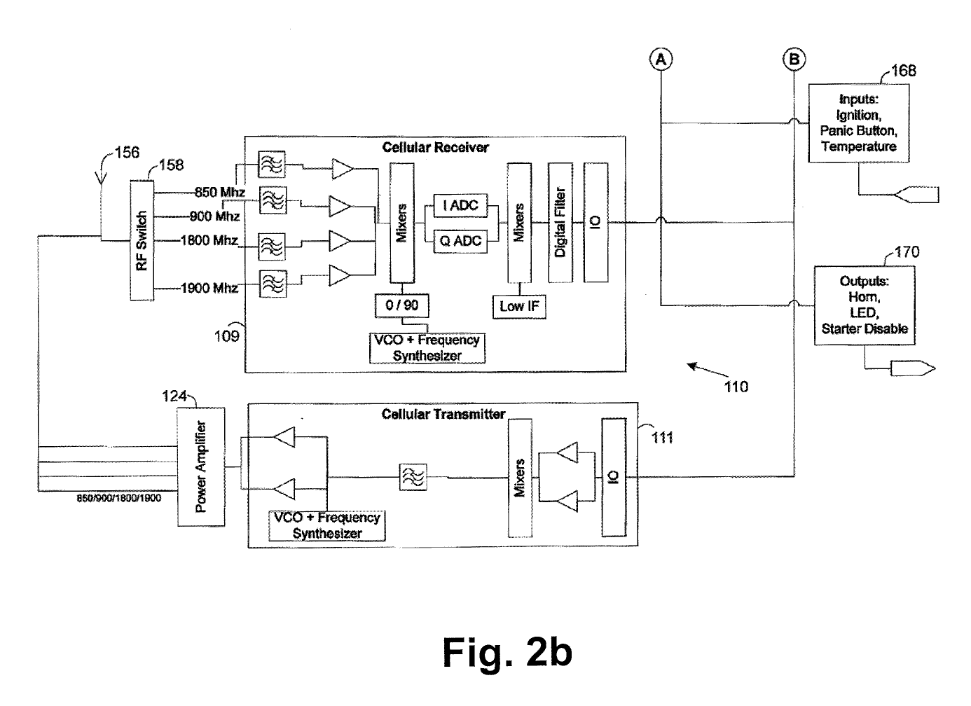

The system may further comprise a Simple Sensor Interface (SSI) 108 for interfacing an RF transceiver 109, which forms part of a cellular subsystem, generally identified with the reference numeral 110 (FIG. 2b), with the CPU 102. The cellular subsystem may also include a cellular antenna 120 for receiving and transmitting data between the system 100 and a remote device (e.g., an emergency response center 176). The SSI protocol is a simple communications protocol designed for data transfer between computers or user terminals and smart sensors. Another port, a universal asynchronous receiver/transmitter (UART) 112, may be used to interface a GPS receiver 114 with the CPU 102. The UART 112 may be on board the CPU 102. The GPS receiver 114 and a GPS antenna 116 form a GPS subsystem, generally identified with the reference numeral 118 (FIG. 2a). Only a single CPU 102 is required, thus the number of associated CPU peripherals is reduced. For example, only a single peripheral 122, which includes peripheral devices and applications, such as an analog to digital converter (ADC) and a watchdog timer, is required. The integrated system 100 also minimizes the power supply requirements of the system and requires only a single power amplifier 124 and a single LDO regulator 126. The system 100 may further comprise one or more input 168 and output 170 devices. Input devices may include, for example, a hazard light device, while output devices 170 may include a car horn, LEDs, lights, etc.

An exemplary schematic of the system 100 is illustrated in FIGS. 2a and 2b. As illustrated, a single CPU 102 may be used to control the entire system 100. The CPU 102 may be, for example, a RISC processor, an ARM 9 RISC processor, or a Model WMP100 wireless microprocessor chip set, as manufactured by WaveCom SA. As mentioned above, the CPU 102 may include on-board UART 112 and SSI 108 ports for interfacing the GPS subsystem 118 and the cellular subsystem 110, respectively, with the CPU 102. The CPU 102 may also have on-board ADC 126, as well as on-board static RAM 128 and ROM 130. The CPU 102 may also have an on-board real-time clock (RTC) 132 and a digitally controlled crystal oscillator (DCXO) 134, controlled by external crystals 138a and 138b, respectively. The crystal 138a may be used to generate the clock speed of the CPU 102. The crystal 138b may be used for development of a real-time clock signal. The CPU 102 may also include a power management unit (PMU) 136, an interrupt controller 180, a direct memory access (DMA) controller 140, internal debug software 142, internal timers 144, a digital signal processor (DSP) accelerator 146, general purpose input output ports (GPIO) 148, and a core processor 150.

The system 100 may include various motion inputs from motion devices that are used to control the power management of the system 100. For example, a gyroscope and/or accelerometer 152 may be coupled to the power management unit (PMU) 136 on board the CPU 102. Thus, while a vehicle is parked, power to the system 100 can be reduced, then later restored when motion of the asset is detected. The motion devices may also be calibrated to detect a collision (e.g., by meeting a specific threshold value), in which case a signal may be communicated to the CPU 102 that a collision has been detected. An additional motion sensor 154, for example, a vibration sensor, may additionally be used to control the power management of the system 100. As shown, the motion sensor 154 is interfaced to the CPU 102 by way of the on-board ADC 126.

One notable feature of the system 100 is the ability to communicate with a remote device. As illustrated, a cellular subsystem 110 may be used for two-way wireless communication between the system 100 and a remote device, such as an emergency response center 176. Other communication systems, such as RF and satellite communication systems, may also be used.

The cellular subsystem 110 includes a cellular receiver 109 and a cellular transmitter 111, which may be included as a part of the WMP100 wireless microprocessor chip set, mentioned above. The cellular subsystem 110 may be a multi-band system operable on various cellular frequencies. As shown, a GSM (Global System for Mobile communications) cellular subsystem is illustrated, which is operable on four (4) frequency bands: 850 MHz, 900 MHz, 1800 MHz and 1900 MHz. Other multi-band and single-band systems are also suitable.

The cellular subsystem 110 also includes a cellular antenna 156 that is coupled to both the cellular receiver 109 and the cellular transmitter 111 for receiving and transmitting data with respect to a remote device. An RF switch 158 may be used to interface the cellular antenna 156 to the cellular receiver 109 to allow selectable use of various frequency bands. The RF switch may be included as part of, for example, the WMP100 wireless microprocessor chip set, mentioned above. The power amplifier 124 may be used to boost the signal from the cellular transmitter 111 before it is directed to the cellular antenna 156. The power amplifier 124 may be, for example, included as a part of the WMP100 wireless microprocessor, mentioned above. Both the cellular transmitter 111 and the cellular receiver 109 may be interfaced to the CPU 102 by way of the on-board SSI 108.

The global positioning system (GPS) subsystem 118 generally includes a GPS antenna 160 and GPS receiver 114. The GPS antenna 160 and GPS receiver 114 are configured to receive satellite signals from GPS satellites. The GPS receiver 114, may be, for example, Model GNS-7560 chip set, as manufactured by NXP Semiconductors. The GPS Search and Track Correlator Engine 107 correlates received signals with specific satellites so that the signals can be used to triangulate the position of the asset. GPS Search and Track Correlator Engine 107 is part of the GPS receiver 114. The GPS subsystem is interfaced with the CPU 102 by way of the UART 112 on board the CPU 102.

Electrical power for the system 100 may be derived from the vehicle power system, for example, the 12-volt DC power system. A conventional power connector may be used to connect the system 100. The vehicle power may be regulated by a voltage regulator 126 and applied to the PMU 136. A battery charger 164 and a lithium ion back-up battery 166 may be provided. The back-up lithium ion battery 166 may be used to provide power to the system 100 when vehicle power supply is unavailable. During conditions when the system 100 is in a low power state, as will be discussed in more detail below, the battery charger 164 may be used to charge the lithium ion back-up battery 166. During states other than a low power state, the battery charger 164 may be configured to enable electrical power from the coaxial cable jack 162 to pass directly to the PMU 136 on board the CPU 102.

There are various inputs 168 and outputs 170 to the CPU 102. These inputs and outputs may all be interfaced with the CPU 102 by way of the on-board GPIO 148. The inputs to the CPU 102 may include a signal from the vehicle ignition wire, which will be either high or low, depending on the state of the ignition system. Other inputs may optionally include an input from a hazard light device, a panic button, a clock, and a temperature input (e.g., a thermometer). The temperature input may be used to monitor the temperature of, for example, the CPU 102.

As will be discussed in greater detail below, an emergency or hazard light device may serve a dual purpose of activating the vehicle's hazard lights and signaling the emergency response center 176 in the event of an emergency. Alternatively, the vehicle's horn may be used to signal the emergency response center 176 when pressed for a preset period of time (e.g., 1-90 seconds, more preferably, 1-60 seconds, even more preferably 5-30 seconds and most preferably, 10-15 seconds).

In certain embodiments, a cancelation button for triggering an cancelation signal may also be integrated with an emergency response system. The cancelation button may be used to terminate an emergency signal and/or to indicate that the emergency signal was inadvertent and should be disregarded. As with the emergency signal button, a cancelation button is preferably a factory-installed button. In certain aspects, the cancelation signal may be communicated when the hazard lights are deactivated. Alternatively, other factory-installed vehicular buttons mad be used to trigger a cancelation signal, including, for example, deactivating the vehicle's multimedia unit. In another aspect, a cancelation signal may be communicated to a remote device when the user calls or texts a cancelation telephone number from a known device (e.g., a device known to be associated with the particular user). Requiring a known device would increase security by verifying the person's identity.

The system 100 may provide one or more output signals. For example, the system 100 may provide a horn signal that can be used to sound the vehicle horn as well as an LED signal that can be used to illuminate an LED in the vehicle in certain conditions. For instance, if a vehicle occupant has indicated that there is an emergency, an indicator on the dashboard may be illuminated to indicate that the request for assistance has been received and/or help is en route. In certain aspects, the vehicle's hazard lights may, alone or in combination with a dashboard indicator, flash at a different rate (e.g., at an increased frequency) to indicate that an emergency signal has been received. In certain embodiments, the system 100 may also provide a starter disable signal that can be used to disable the vehicle starter (not shown).

In order for an emergency response center 176 to be able to distinguish the various systems 100 in the field, a Subscriber Identity Module (SIM) 172, which securely stores the service-subscriber key used to identify a subscriber of the system, may be coupled with the CPU 102. The SIM 172 may also be used to store user-level configuration data, emergency contact information, and loan account data for systems equipped with an optional loan obligation management system.

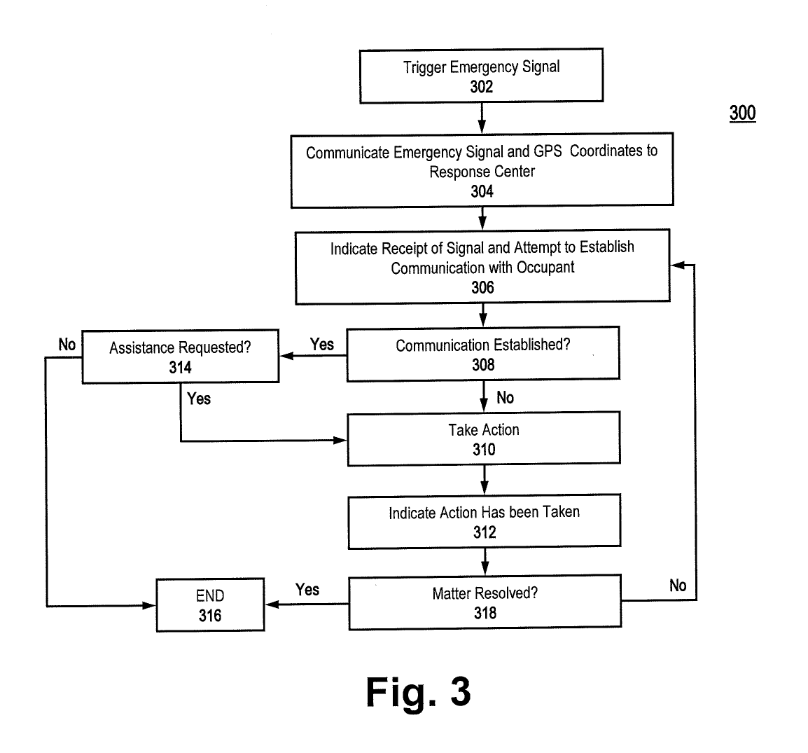

Turning now to FIG. 3, a flow diagram is provided to illustrate an exemplary method 300 for carrying out emergency response functionality. At step 302, an emergency signal is generated. Depending on the preferences and needs of the user and/or service provider, the emergency signal may be generated, or triggered, in one of multiple ways.

For instance, the emergency signal may be triggered immediately upon activation of the hazard lights, which are activated using the emergency or hazard light device. Alternatively, the emergency signal may not be generated until the hazard light device has been triggered for a preset period of time (e.g., 2-60 seconds, more preferably, 2-30 seconds, even more preferably 2-15 seconds and most preferably, 2-5 seconds). Requiring that the device, such as a button, be triggered (i.e., pressed) for a preset period of time reduces inadvertent emergency signal generation. For instance, in a situation where the driver wishes to use his hazard lights to double park, he may not wish to signal an emergency signal. Requiring that the button be pressed for a preset period of time can greatly reduce, or eliminate, this risk.

In another alternative, the emergency signal may not be generated until the hazard lights have been active (i.e., flashing) for a preset period of time (e.g., 1-60 minutes, more preferably, 1-30 minutes, even more preferably 5-20 minutes and most preferably, 10-15 minutes). This configuration may be beneficial in instances where the vehicle operator parked the vehicle with the intention of returning within a short time period, but for one reason or another, was unexpectedly detained (e.g., locked out of the vehicle, lost, kidnapped, robbed, etc.). In yet another alternative, the emergency signal may be generated through a combination of the foregoing methods or by other events, such as crash detection (e.g., using a gyroscope or airbag deployment as a triggering event).

Regardless of the method for triggering the emergency signal at step 302, once the emergency signal has been generated, the emergency signal may then be communicated to an emergency response center at step 304. In additional to the emergency signal, the vehicle's GPS coordinates may also be communicated to the emergency response center. If the vehicle is in motion, it may also be advantageous to dynamically provide the emergency response center with the vehicle's speed and direction in order to effectively track its location.

Once the emergency response center has received the emergency signal, the emergency response center may acknowledge receipt of the signal and attempt to establish communication with the vehicle occupant at step 306.

Acknowledgment may be indicated using a dashboard indicator such as, for example, an LED that may be illuminated upon receipt or, alternatively, an LCD display that may be used to indicate receipt (e.g., via an icon or textual display), optionally along with other useful information. Alternatively, the car's hazard lights may be configured to flash at a different rate (e.g., a higher frequency) and/or the horn may be activated to produce a tone for a present period of time (e.g., 0.01-5 seconds, more preferably, 0.05-3 seconds, even more preferably 0.1-2 seconds and most preferably, 0.5-1.5 seconds) to confirm that the emergency signal has been received.

As more recent vehicles are factory-equipped with both speakers and microphones, communication may be accomplished using the system's cellular network and the vehicle's existing speakers and microphone. If the system is unable to communicate with the vehicle occupant using the foregoing method, the emergency response center may be instructed by, for instance, a set protocol to dial a stored phone number associated with the vehicle. A set protocol may be a general protocol or specific to each individual user. For example, a user may have one or more emergency contact numbers on file and associated with a set protocol, including his or her mobile phone number, a home number, a work number, and/or the number for a friend/family member.

If communication has been successfully established at step 308, the emergency response center may solicit information from the user to determine whether assistance is requested. If the vehicle occupant indicates that assistance is not needed at step 314 (e.g., the emergency signal was inadvertent, or the matter has already been resolved), the emergency system process may terminate at step 316. However, if the vehicle occupant indicates that assistance is needed at step 314, the emergency response center may take action at step 310. Such action may include dispatching emergency assistance as requested by the vehicle occupant, or soliciting additional information to determine the appropriate form of emergency assistance. For example, if the user has a flat tire, sending the fire department may be excessive because a tow truck would provide adequate assistance.

If communication has not been established at step 308, the emergency response center may follow a preset action protocol at step 310. For instance, to err on the side of caution, the emergency response center may automatically dispatch the police to the vehicle's current GPS coordinates to investigate the non-responsive emergency signal. However, the form and type of action may be preset by the user and described in a set protocol associated with the user. For instance, the user may request that the emergency response center take no action unless a second emergency signal is received within a set period of time. Alternatively, the user may prefer that assistance only be dispatched if the vehicle is located in a particular geographical area, such as outside of a predefined area. In an embodiment where a hazard light device is used to trigger the emergency signal, this geographical area restriction would prove useful if the user habitually triggers the hazard lights when parking near a certain landmark (e.g., a primary residence, workplace, etc.).

Once action has been taken at step 312, the emergency response center may indicate to the user that action has been taken using a dashboard indicator. As with the acknowledgment indicator, an action indicator may be facilitated using, for example, an LED that may be illuminated upon action, or an LCD display to indicate action has been taken (e.g., via an icon or textual display).

To conserve space, the action indicator of step 312 and the receipt indicator of step 306 may share a single dashboard indicator. According to this aspect, the LED may switch from off to a first color (e.g., yellow) upon receipt of the emergency signal, and then to a second color (e.g., green) once action has been taken. Similarly, when using an LCD display, a first icon, or string of text, may be displayed upon receipt of the emergency signal and replaced, or supplemented, with a second icon or string of text once action has been taken.

Alternatively, as with the acknowledgment indicator, the car's hazard lights may be configured to flash at yet a different rate (e.g., a higher frequency) and/or the horn may be activated to produce a tone for a present period of time (e.g., 0.01-5 seconds, more preferably, 0.05-3 seconds, even more preferably 0.1-2 seconds and most preferably, 0.5-1.5 seconds).

Once action has been taken at step 312, the emergency response center may confirm that the emergency matter has been resolved at step 318. The emergency response center may determine this by soliciting information from the dispatched emergency personnel or the vehicle's occupant. If the emergency response center determines that the emergency has been resolved, the process may terminate at step 316. However, if the emergency response center determines that the emergency has not been resolved, the process may return to step 306.

While the present invention has been described with respect to what are currently considered to be the preferred embodiments, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation, so as to encompass all such modifications and equivalent structures and functions.

All U.S. and foreign patent documents, all articles, all brochures, and all other published documents discussed above are hereby incorporated by reference into the

### DETAILED DESCRIPTION OF THE PREFERRED EMBODIMENT

What is claimed is:

1. A method for activating a vehicular emergency response system, comprising the step of triggering a factory-installed hazard light device.

2. The method of claim 1, wherein the hazard light device is a factory-installed button.

3. The method of claim 2, wherein the emergency response system is triggered by pressing the factory-installed button.

4. The method of claim 2, wherein the emergency response system is triggered by pressing and holding the factory-installed button for at least 3 seconds.

5. A method for using a factory-installed hazard light device in a vehicle to activate an emergency response system, comprising the steps of:
generating an emergency signal in response to the hazard light device being triggered; and
transmitting said emergency signal to an emergency response center, wherein said emergency response center is enabled to take appropriate action in response to the emergency signal.

6. The method of claim 5, further comprising the step of generating GPS location data associated with the vehicle.

7. The method of claim 6, further comprising the step of transmitting the GPS location data and the emergency signal to the remote device, wherein the remote device is enabled to determine the location of the vehicle using the transmitted location data.

8. The method of claim 5, wherein the appropriate action is one or more of the following actions: (i) dispatching emergency personnel to the location of the vehicle; (ii) dialing a phone number associated with the vehicle; (iii) contacting an emergency contact associated with the vehicle; and (iv) notifying a government agency of the emergency.

9. The method of claim 5, wherein the factory-installed hazard light device is a factory-installed button and the emergency response system is triggered by pressing and holding the factory-installed button for at least 3 seconds.

10. A method for using a factory-installed hazard light device in a vehicle to activate a vehicular emergency response system, comprising:
receiving an emergency signal triggered by the factory-installed hazard light device, wherein said factory-installed hazard light device is further enabled to activate the vehicle's hazard lights;
generating GPS location data associated with the vehicle;
establishing a communication link between the vehicle and a remote device; and
transmitting the GPS location data and the emergency signal to the remote device, wherein the remote device is enabled to determine the location of the vehicle using the transmitted location data.

11. The method of claim 10, wherein said remote device is an emergency response center.

12. The method of claim 10, wherein the emergency response center is enabled to take appropriate action in response to said emergency signal.

13. The method of claim 12, wherein the appropriate action is one or more of the following actions: (i) dispatching emergency personnel to the location of the vehicle; (ii) dialing a phone number associated with the vehicle; (iii) contacting an emergency contact associated with the vehicle; and (iv) notifying a government agency of the emergency.

14. The method of claim 10, wherein the factory-installed hazard light device is a factory-installed button and the emergency response system is triggered by pressing and holding the factory-installed button for at least 3 seconds.

15. A vehicular emergency response system, comprising:
a factory-installed hazard light device used to activate the vehicle's hazard lights and also used for triggering an emergency signal;
a CPU operatively coupled to said hazard light device and a memory device;
a GPS device operatively coupled to said CPU and enabled to provide location data associated with the vehicle; and
a communication device operatively coupled to said CPU for establishing a communication link with a remote device to transmit to the remote device the location data and the emergency signal.

16. The system of claim 15, wherein said remote device is an emergency response center.

17. The system of claim 16, wherein the emergency response center is enabled to take appropriate action in response to said emergency signal.

18. The system of claim 17, wherein the appropriate action is one or more of the following actions: (i) dispatching emergency personnel to the location of the vehicle; (ii) dialing a phone number associated with the vehicle; (iii) contacting an emergency contact associated with the vehicle; and (iv) notifying a government agency of the emergency.

19. The system of claim 15, wherein the factory-installed hazard light device is a factory-installed button and the emergency response system is triggered by pressing and holding the factory-installed button for at least 3 seconds.

20. An emergency response apparatus in a vehicle, comprising:
a factory-installed dashboard on which is mounted a factory-installed emergency or hazard light device used to activate the vehicle's hazard lights; and
a CPU, wherein said CPU is configured to receive as an input an emergency signal triggered by said factory-installed emergency or hazard light device and to establish a communications link with a device remote from the vehicle in response to the receipt of said emergency signal.

21. The system of claim 20, wherein said remote device is an emergency response center.

22. The system of claim 20, wherein the system includes a GPS device coupled to said CPU for providing location data associated with the vehicle, said the emergency response center is enabled to take appropriate action in response to the receipt of said emergency signal and said location data.

23. The system of claim 22, wherein the appropriate action is one or more of the following actions: (i) dispatching emergency personnel to the location of the vehicle; (ii) dialing a phone number associated with the vehicle; (iii) contacting an emergency contact associated with the vehicle; and (iv) notifying a government agency of the emergency.

24. The system of claim 20, wherein the factory-installed hazard light device is a factory-installed button and the emergency response system is triggered by pressing and holding the factory-installed button for at least 3 seconds.
